(19) United States
(12) Patent Application Publication
(10) Pub. No.: US 2007/0233456 A1
(43) Pub. Date: Oct. 4, 2007

(54) Document localization

(75) Inventor: Youn Gon Kim, University Place, WA (US)

Correspondence Address: MERCHANT & GOULD PC, P.O. BOX 2903, MINNEAPOLIS, MN, 55402-0903, US

(73) Assignee: Microsoft Corporation, Redmond, WA (US)

(21) Appl. No.: 11/396,065

(22) Filed: Mar. 31, 2006

(51) Int. Cl. G06F 17/28

(52) U.S. Cl. 704/2

(57) ABSTRACT

Methods for localizing documents may include tokenizing a document to extract localizable text data from the document. The tokenization may in some instances create skeleton pages that contain a global presentation structure for the documents, and resource pages that contain the localizable text data in the form of localizable terms that are translated from the source language into the target language. Access to the resource pages is provided to allow the localizable text data in the source language, to be translated into the target language. The localized documents may then be generated by merging the translated text data into the global presentation structure.

### BACKGROUND

With the advent of modern technology, including the Internet and computers, information can be transferred all over the world very quickly. However, despite having the facility to transfer and access information quickly, people are still limited by their understanding of the language in which the information is presented. Thus, translating information into various languages is still an important part of information transfer. In particular, businesses that sell products or services in a number of countries require large amounts of information to be translated. One relatively small example of this problem involves software companies that sell products in a number of countries needing to have instructional materials, such as user guides, manuals and pamphlets that accompany the software, translated into a number of different languages.

Complicating the problem is the fact that electronic documents may be in a variety of electronic formats, such as proprietary word processing or data publishing formats for printed material, and in HTML format for web site information. As a result, documents are typically translated on a document-by-document basis, for each language. A large amount of effort is expended in translating information on a document-by-document basis, because for each document translated, the source document and the translated document must be tracked. Moreover, when documents are revised in the source language, the changes cannot be easily tracked, resulting in the need to retranslate the entire document in every language. These problems are compounded by the fact that business may require thousands of documents to be translated into multiple languages.

It is with respect to these and other considerations that the present invention has been made. Also, although relatively specific problems have been discussed, it should be understood that embodiments of the present invention should not be limited to solving these problems, and in fact may address other issues.

### SUMMARY

This summary is provided to introduce a selection of concepts in a simplified form that are further described below in the Detail Description Section. This summary is not intended to identify key features or essential features of the claimed subject matter, nor is it intended to be used as an aid in determining the scope of the claimed subject matter.

Embodiments of the present invention provide a streamlined process for translating documents from a source language to a target language. The process relates to separating the document into a localizable portion that includes text data, and a global portion that includes presentation structure. The localizable portions include text data that is stored in a database system and translated into the target language. The translated text data can later be merged with the presentation structure to create localized documents in the target language. In some embodiments, the translated text data may be recycled and used to generate a number of other localized documents.

In other aspects, embodiments of the present invention relate to data structures that are utilized in generating localized documents and in managing large localization projects. The data structures may include a variety of information including information representing localizable terms extracted from a source document, and information representing translated terms generated by translating the localizable terms into a target language, and relationship information indicating a relationship between the source documents and the extracted localizable terms. The data structure may be used in generating a localized document by examining the information representing the translated terms to retrieve the translated terms, examining information indicating a relationship between the source documents and the extracted localizable terms, and incorporating the translated terms into a localized document based on the relationship represented by the relationship information.

The invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

FIG. 1 illustrates an environment for implementing embodiments of the present invention.

FIG. 2 illustrates a suitable computing system environment on which embodiments of the present invention may be implemented.

FIG. 3 illustrates tokenizing according to an embodiment of the present invention.

FIG. 4 illustrates an application for translating localizable text data.

FIG. 5 illustrates functional aspects of a method of generating localized documents.

FIG. 6 illustrates functional aspects of an exemplary method of extracting localizable text data from a source document.

FIG. 7 illustrates functional aspects of a method of translating localizable text data.

FIG. 8 illustrates functional aspects of a method of managing the localization of a source document.

### DETAILED DESCRIPTION

The term “localization” generally refers to the process of creating language specific versions of documents or software. Consequently, a part of localization includes translating text authored in an original language, sometimes referred to as the source language, into another language, sometimes referred to as a target language. In an embodiment, the present invention involves streamlining the process of localizing a document by separating localizable text data (information to be translated) from a global presentation structure that includes style information (information that determines the rendering of a document), translating the localizable text data and generating a localized document using the translated text data.

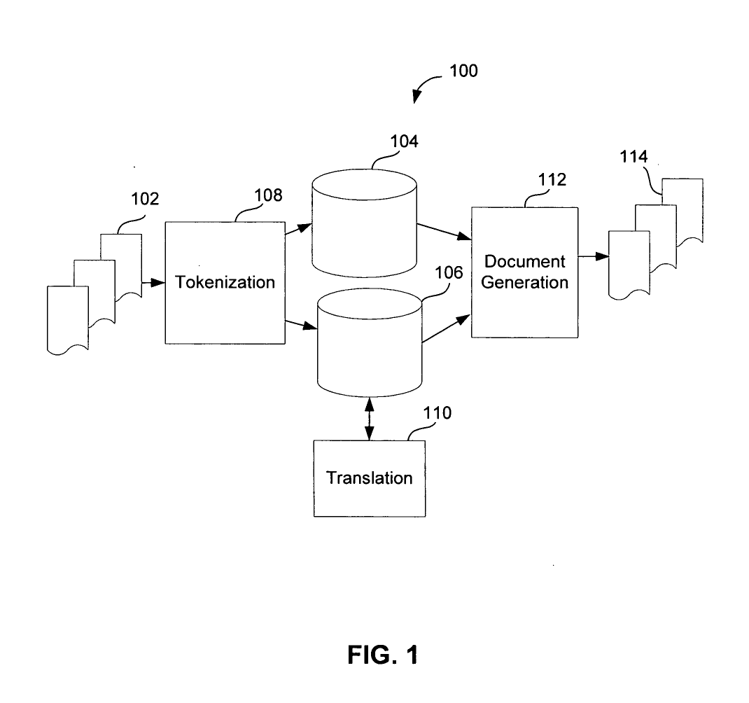

FIG. 1 illustrates an environment 100 for implementing an embodiment of the present invention. System 100 includes source documents 102, that are to be localized, and databases 104 and 106. Additionally, environment 100 includes a tokenization process 108, a translation process 110 and a localized document generation process 112.

Source documents 102 were created in some source language (e.g., English) and require localization into a target language (e.g., Spanish). The documents may include a wide variety of types including, but not limited to, word processing, spreadsheet, publishing, and web pages. Accordingly, source documents 102 may be in a variety of formats including proprietary formats, or universal formats such as XML or HTML, depending on the type of document and the method by which the documents were created.

The source documents 102 undergo tokenization 108 to extract localizable text data from the source documents 102. Tokenization is intended to be a general term for a process that extracts localizable text data from source documents, and although described with specific features below is not limited thereto. Tokenization 108 extracts the localizable text data. The localizable text data is in the form of localizable terms. “Terms” is intended to mean individual words or a combination of words (e.g., phrases, sentences, paragraphs, pages etc.). Tokenization 108 results in the creation of linear localizable text data and non-linear global presentation structure. The global presentation structure contains style information and other information that relates to rendering the source documents 102. For example, the global presentation structure may contain style information regarding font style, color and type, which may be necessary for rendering some text as a heading with bold or other style features, and other text with no style features. The localizable text data is in the form of localizable terms. The localizable text data is the information that needs to be translated from the source language into the target language for localizing source documents 102. In environment 100, the global presentation structure is stored in database 104 and the localizable text data is stored in database 106. It should be understood that in other implementations, the global presentation structure and the localizable text data may be stored in a single database, or in two or more databases.

The localizable text data stored in database 106 undergoes translation 110. Because the localizable text data is in the form of localizable terms, the translation 110 may occur on a term-by-term basis. The ability to translate smaller portions of a document at a time, i.e., a few terms, provides a number of advantages (described in greater detail below) over conventional document-by-document translation processes. Translation 110 involves translating the localizable text data from the source language, for example English, into the desired target language, for example, Spanish. As one example, translation 110 may involve the use of automatic language translation software that will automatically translate words from one language into another. As another example, translation 110 may involve the use of human translators, people who translate information from one language into another, such as freelance translators. Translation 110 may involve a number of steps, such as accessing the localizable text data from database 106, translating the localizable text data to generate translated text data, and storing the translated text data in database 106.

After the localizable text data undergoes translation 110, the localized document generation 112 generates the localized documents 114. Localized documents 114 correspond to source documents 102 in that they are translated documents of source documents 102. Localized document generation 112 involves integrating the global presentation structure in database 104 with translated text data stored in database 106. The document generation 112 involves using the translated text data from database 106 and the global presentation structure from database 104 to create localized documents 114 that have the same style information as the documents 102, however incorporate the translated text data. Although environment 100 shows the global presentation structure as passing from database 104 into localized documents 114, the global presentation structure is merely intended to illustrate that presentation and style information, originally from documents 102, is incorporated in localized documents 114. In some embodiments, the global presentation structure may be modified or converted is some way prior to being used in document generation 112 to generate localized documents 114. As is described in more detail below, document generation 112 may be performed using any suitable software application for integrating the global presentation structure and the translated text data.

Environment 100 provides a number of advantages over conventional environments for localizing documents. As is illustrated in greater detail below, separating localizable text data, as words or combinations of words, from the global presentation structure of a document (e.g., style information) eliminates file management issues associated with conventional systems, allows for efficient translation of updated text data, and provides a way of tracking the progress of a large localization project.

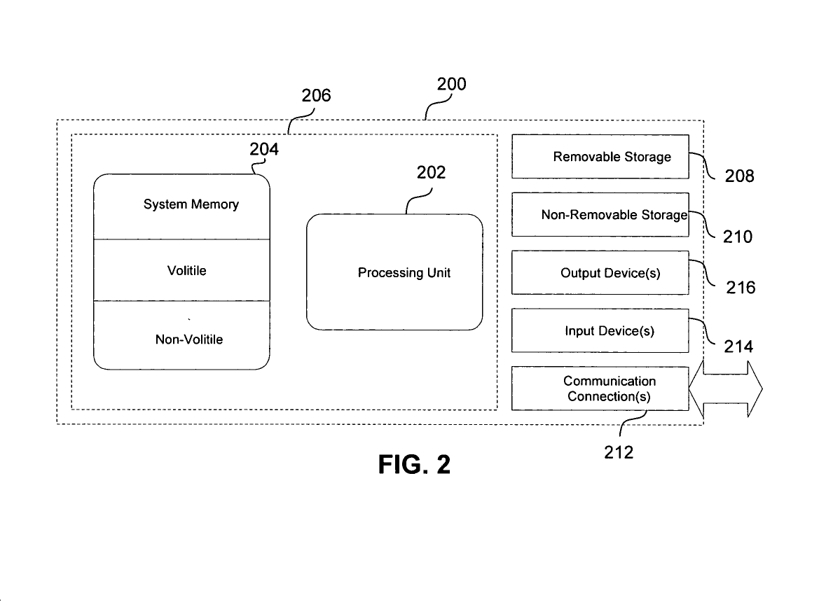

FIG. 2 illustrates an example of a suitable computing system environment on which embodiments of the present invention may be implemented. This system 200 is representative of computing systems that may be used to run software applications for performing the tokenization 108 or the localized document generation 112 described above. In its most basic configuration, system 200 typically includes at least one processing unit 202 and memory 204. Depending on the exact configuration and type of computing device, memory 204 may be volatile (such as RAM), non-volatile (such as ROM, flash memory, etc.) or some combination of the two. This most basic configuration is illustrated in FIG. 2 by dashed line 206. Additionally, system 200 may also have additional features/functionality. For example, device 200 may also include additional storage (removable and/or non-removable) including, but not limited to, magnetic or optical disks or tape. Such additional storage is illustrated in FIG. 2 by removable storage 208 and non-removable storage 210.

Computer storage media includes volatile and nonvolatile, removable and non-removable media implemented in any method or technology for storage of information such as computer readable instructions, data structures, program modules or other data. Memory 204, removable storage 208 and non-removable storage 210 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by system 200. Any such computer storage media may be part of system 200.

System 200 may also contain communications connection(s) 212 that allow the system to communicate with other devices. Communications connection(s) 212 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

System 200 may also have input device(s) 214 such as keyboard, mouse, pen, voice input device, touch input device, etc. Output device(s) 216 such as a display, speakers, printer, etc. may also be included. All these devices are well know in the art and need not be discussed at length here.

Below is a more detailed description of some features, components, processes and/or steps of some embodiments of the present invention. It should be noted that the specific details described below are not intended to limit the scope of the invention and are provided for illustrative purposes only.

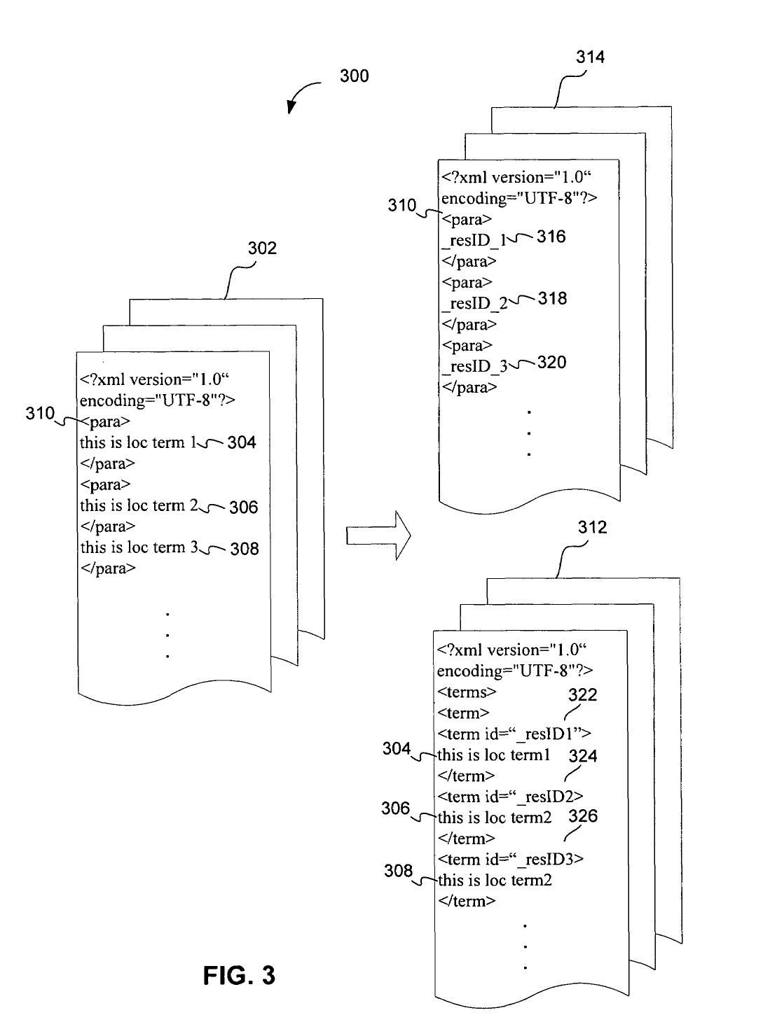

FIG. 3 illustrates an example of a tokenization process 300 that may be implemented as tokenization 108 described above with respect to FIG. 1. As discussed above, tokenization 108 accepts source documents 102 and separates the document into localizable text data and a global presentation structure. The documents 102 are shown in more detail as documents 302, as a particular example. In the embodiment illustrated in FIG. 3, documents 302 are in an XML format, although, in other embodiments documents 302 may be in some other format, nonlimiting examples including HTML and PDF. Documents 302 include style information 310, which is part of the global presentation structure of the documents 302 and localizable text data in the form of localizable terms 304, 306 and 308. Localizable terms 304, 306 and 308 may be words, sentences, or paragraphs of documents 302 that are in a source language such as English, and are to be translated into a target language such as Spanish in order to localize the documents 302 for a country corresponding to the target language. As previously described, style information 310 is information that indicates how the localizable text data is rendered in the documents 302. For example in FIG. 3, style information 310 indicates that the localizable terms 304, 306 and 308 are part of a paragraph in documents 302. There may be some style information (font size, type, color) associated with being rendered as part of a paragraph in documents 302.

The tokenization process 300 extracts the localizable terms 304, 306 and 308 from documents 302, and creates resource pages 312 and skeleton pages 314. Skeleton pages 314 contain the style information 310 and other portions of the global presentation structure of documents 302, and in place of the extracted localizable terms 304, 306 and 308 are resource identification, or ResourceID (“resID”) numbers 316, 318 and 320. ResourceID numbers may be thought of as placeholders for localizable terms 304, 306 and 308. The resource pages 312 include the extracted localizable terms 304, 306 and 308, which are associated with ResourceID numbers 322, 324 and 326. ResourceID numbers 322, 324 and 326 correspond to ResourceID numbers 316, 3.18 and 320 respectively. The ResourceID numbers (316, 318, 320, 322, 324 and 326) collectively are used to keep track of the style information 310 that correspond to the localizable terms 304, 306 and 308. The ResourceID numbers (316, 318, 320, 322, 324 and 326) may, in some embodiments, be thought of as representing a relationship between the localizable terms 304, 306 and 308 and the documents 302. For example, the ResourceID numbers (316, 318, 320, 322, 324 and 326) may indicate that the localizable terms are part of a particular paragraph, that is on a specific page and are rendered with specific style elements in the source documents 302. The ResourceID numbers (316, 318, 320, 322, 324 and 326) are persisted throughout the localization process.

It should be noted that tokenization process 300 is for purposes of illustration. In alternative embodiments, the tokenization may not actually create skeleton pages with the global presentation structure; rather the skeleton pages and the global presentation structure may merely be the source documents, with the localizable text data replaced with reference or the ResourceID numbers. As previously described, tokenization is intended to be general and refer to a process that includes extracting localizable text data from documents.

The tokenization process may be performed using a suitable software application. For example, a parser program may be used to identify and extract the localizable text data from the global presentation structure. Those with ordinary skill in the art will understand that a parser program may use one or more of a parser engine and grammar rules to scan input (a sequence of characters) and distinguish and extract specific sequences within the input. Those with skill in the art will understand that the specific parser programs that may be used to tokenize documents will depend on the format of the documents. For example, one parser program may be programmed to tokenize XML documents, while another parser program may be developed to tokenize documents in PDF format. Parser programs are merely one example of suitable software for tokenizing documents in accordance with embodiments of the present invention. It should be understood that any software application that separates a document into localizable linear text data and a global presentation non-linear structure may be used for implementing the present invention.

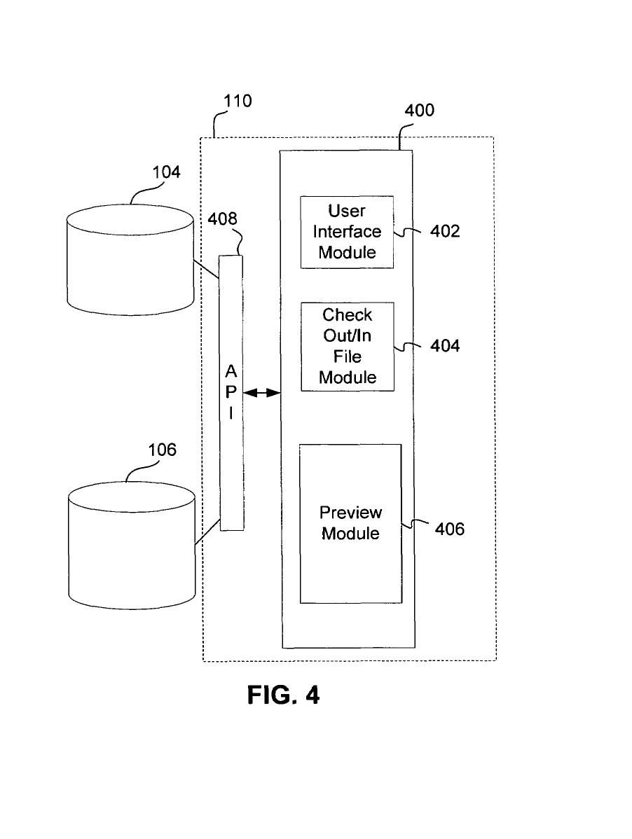

After tokenizing the documents, the extracted localizable text data is translated into the target language. FIG. 4 illustrates an application 400 that may be used in some embodiments of the present invention as part of the translation 110 described in FIG. 1. Application 400 may be used by human translators, e.g., freelance translators, tasked with translating the localizable terms in resource pages stored in database 106. Application 400 includes a user interface module 402, a check out/in module 404, and a preview module 406. In some embodiments, application 400 is installed on a single computing system such as system 200 described above with respect to FIG. 2. In other embodiments, application 400 is used in a distributed computing environment that includes a number of different computing systems 200, in for example a server-client network. In those embodiments, different modules of application 400 may be installed on different clients and/or servers in the server-client network.

As illustrated in FIG. 4, application 400 has access to database 104, which stores skeleton pages with global presentation structure and database 106, which stores resource pages with localizable text data. Application 400 accesses databases 104 and 106, through any of the communications media described above with respect to FIG. 2 and computing system 200. Additionally, in some embodiments an application-programming interface (API) 408 is utilized by application 400 for accessing databases 104 and 106.

User interface module 402 may provide an interface for a translator to use application 400, and to access resource pages in database 106 in order to translate localizable text data. In one embodiment, user interface module 402 operates on a client computer that is connected to a server, which has access to database 106. The client and server are connected for example through the Internet. A translator who may be located anywhere in the world may utilize user interface module 402 to access resource pages in database 106, translate the localizable text data in the resource pages and then store the translated text data in database 106.

Check out/in module 404 keeps track of particular resource pages that have been checked out of database 106 for translating. In one embodiment, check out/in module 402 operates on a server computer, which has access to database 106. The server computer may be connected to a network such as an intranet or the Internet. A translator will use a client computer to connect to the server computer and utilize check out/in module 404 to download resource pages for translating. At a later time, the translator will use check out/in module 404 to upload the translated text data into database 106.

Preview module 406 is used to allow a translator to preview localized documents that incorporate translated text data that they have newly translated. The preview module 406 is used to integrate the skeleton pages stored in database 104 with translated text data provided by a translator. Preview module 406 will then render localized documents for a translator to preview. Preview module 406 advantageously provides translators with immediate feedback that they can use to determine whether their translations of the localizable text data should be modified. The operation of preview module 406 is similar to the generation of localized documents, described in more detail below.

Application 400 is merely one example of an application that may be used by human translators for translating localizable text data extracted from source documents. In other embodiments, translation of localizable text data may be accomplished by merely delivering a copy of the localizable text data to the translator using a computer readable media, such as a CD or electronic mail message. The translator then hands back the translated text data on a computer readable media, which is then stored in database 106. In yet other embodiments, the translation of localizable text data may be performed using automatic language translation software instead of, or in addition to, the use of a human translator.

The process of generating localized documents by integrating, or combining, the translated text data with the global presentation structure may be performed using any suitable combination of steps, methods or applications. By integrating or combining, it is meant that the global presentation structure and the translated text data are associated in a way that provides for the global presentation structure to determine how the translated text data is displayed in the translated document. First, it should be understood that the global presentation structure merely represents a structure that has presentation and style information from source documents that will be applied to localized documents containing the translated text data. It is not necessary that the global presentation structure generated from the tokenizing be in the same form, when used to generate the localized documents, although in some embodiments it may be. In embodiments, the global presentation structure is expressed in an XML format or Extensible Stylesheet Language Transformations (XSLT). In these embodiments, generating the localized documents may involve the use of an XSLT processor, which is software that is well known in the art for transforming an XML document into another document, which may be in a number of formats, e.g., XML, HTML, PDF, etc. In this embodiment, the translated text data may be stored in an XML format that is then transformed according to the XSLT or XML global presentation structure using an XSLT processor to generate the localized document. This is merely one example, and those with skill in the art will appreciate other steps, processes, or applications for generating the localized documents from the translated text data and the global presentation structure.

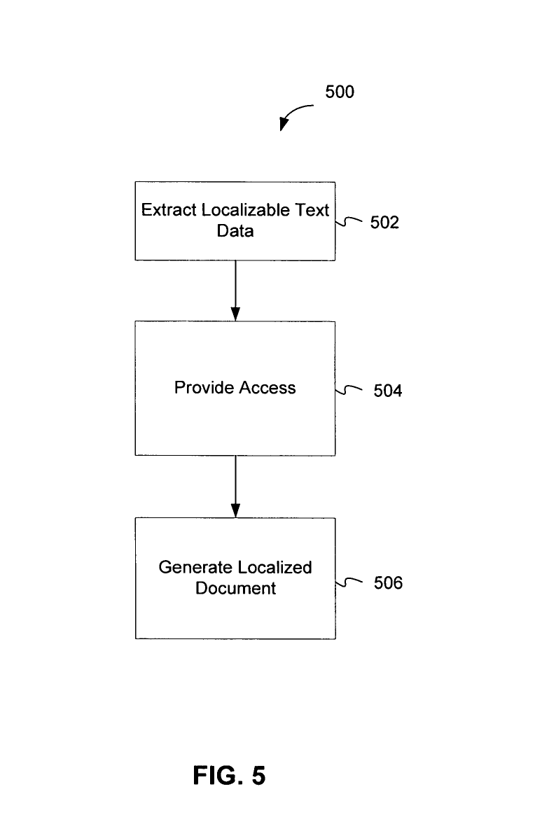

FIG. 5 shows a flowchart 500 illustrating a process for generating a localized document according to one embodiment of the present invention. In this embodiment, an extract localizable text data operation 502 extracts localizable text data in the form of localizable terms from the source document that is to be localized. The source document includes localizable text data and a global presentation structure. Operation 502 may be performed using any process, method, or steps that extracts the localizable text data from the source document. For example, operation 502 may involve the tokenization processes described above with respect to FIG. 3, which creates resource pages containing the localizable text data, as well as skeleton pages containing the global presentation structure of the source document.

After the extract localizable text data operation 502, provide access operation 504 allows the localizable text data to be accessed for translation of the localizable terms that make up the localizable text data to form translated terms. The provide access 504 may be implemented by for example translation application 400 described above with respect to FIG. 4. In other embodiments, provide access 504 may be implemented by storing a copy of resource pages with the localizable text data on a computer storage media, and handing off the storage media to a human translator. In yet other embodiments, provide access 504 may be implemented by allowing automatic language translation software to retrieve the localizable text data for translating the localizable terms into translated terms.

After providing access 504, the localized document is generated 506. As stated above, the localized documents may be generated by integrating the global presentation structure with the translated terms. As one example, the translated terms may be in a linear XML format and the global presentation structure may be in a non-linear XML or XSLT format. The translated terms are either merged into the global non-linear XML structure, or transformed according to the XSLT using an XSLT processor, to generate the localized document.

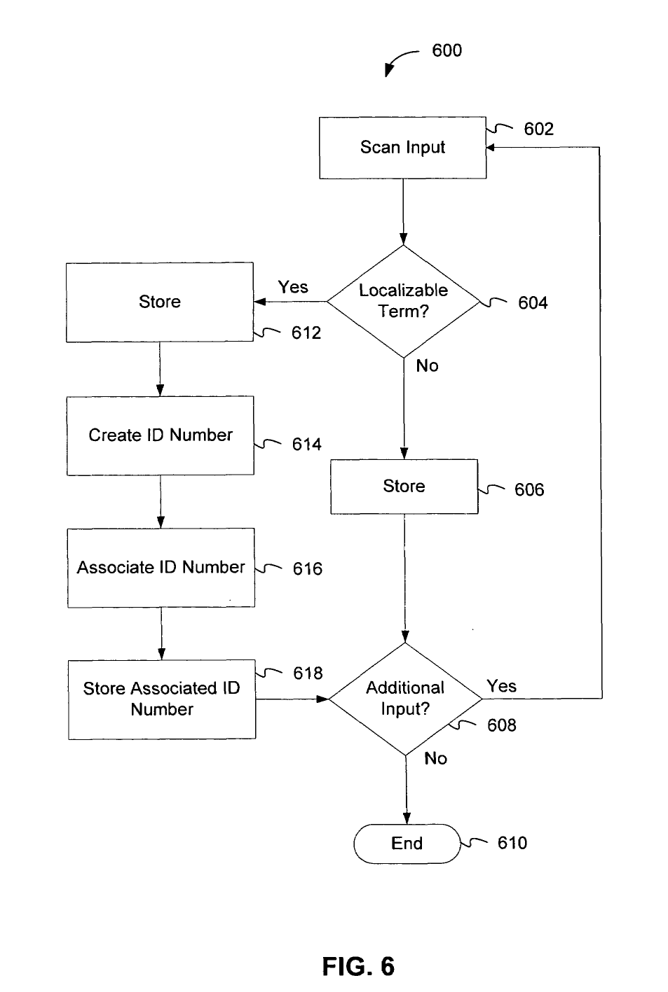

FIG. 6 shows a flow chart 600 illustrating a process of extracting localizable text data from a source document according to one embodiment of the present invention. Scan input operation 602 is performed on a string or sequence of characters from the source document. The string of characters may be for example a line of source code or some other portion of a source document that may contain localizable text data. At decision 604, a determination is made as to whether the input is a localizable term. As an example, the scan operation 602 and the decision 604 may be performed using a parser program that includes a parser engine for scanning the input, and grammar rules for determining whether the input is a localizable term.

If the input is not a localizable term, it is some portion of the global presentation structure, e.g., style information relevant to rendering the source document. Accordingly, store operation 606 will store the input as being part of global presentation structure, in for example a skeleton page. After store operation 606 a decision is made at decision 608 as to whether there is additional input to scan. If there is no additional input, the process ends at 610. However, if there is additional input to scan, control will loop back to scan input operation 602 to scan additional input.

If at decision 604 it is determined that the input is a localizable term, store operation 612 stores the localizable term, for example in a resource page. Following store operation 612, an ID number that will be used to track the relationship of the localizable term with the source document is created at create ID number operation 614. Associate ID number operation 616 associates the ID number with the localizable term in the resource page, such as inserting the ID number in the resource page.

At store associated ID number operation 618, the ID number associated with the localizable term is stored in a skeleton page to keep track of the part of the global presentation structure, such as style information, that corresponds to the localizable term. At decision 608 a determination is made whether there is additional input to scan. If so, control is returned to scan input operation 602, otherwise the process ends at 610.

It should be noted that the description of the extraction process 600 is for purposes of illustration. In other embodiments, extracting localizable text data from source documents may involve fewer operations. For example, in those embodiments where the skeleton pages are merely the source document with ID numbers replacing localizable terms, operation 606 can be eliminated.

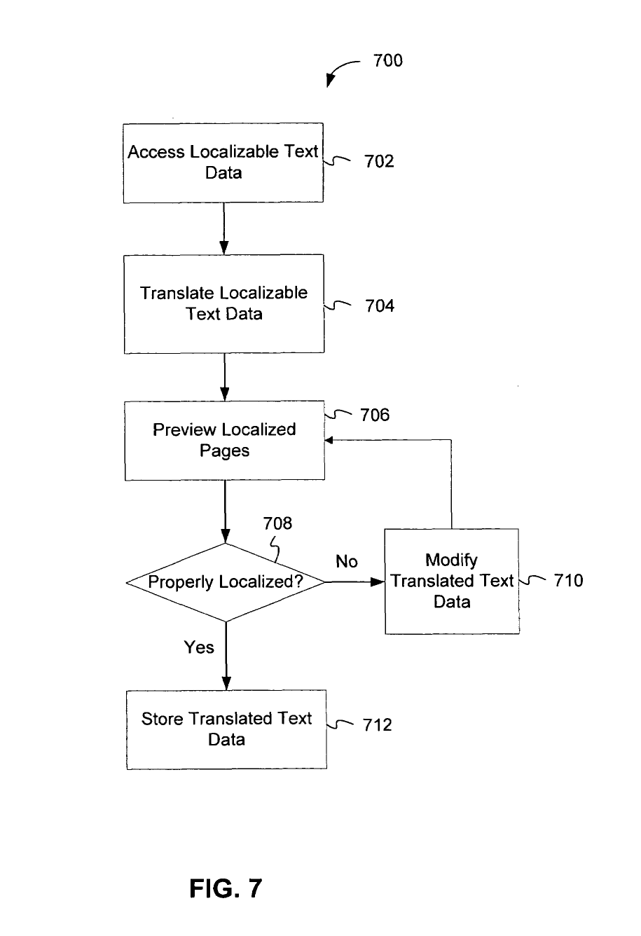

FIG. 7 shows a flowchart 700 illustrating a process for translating localizable text data according to one embodiment of the present invention. Localizable text data is accessed at operation 702. As previously described, if a human translator will perform the translation the access may be provided through a client-server network or by providing copies to a translator through a computer readable media, such as a CD or electronic mail message. If the translation is being performed by automatic language translation software, the access may merely entail allowing the translation software to retrieve the localizable text data in the resource pages.

After accessing the localizable text data 702, the localizable text data is translated at translate localizable text data 704 to generate translated text data. Translating the localizable text data from the source language to the target language may involve the use of automatic translation software and/or human translators, as previously described.

Localized pages are previewed 706, after the localizable text data is translated 704. By “localized pages” it is meant portions of a localized document that include the translated text data. Previewing localized pages 706 involves integrating the translated text data with the global presentation structure. After previewing the localized pages 706, a determination is made at decision 708 to determine whether the localized pages are properly localized. If they are not properly localized, such as for example, if terms have not been translated correctly, or do not convey the intended meaning, the translated text data may be modified at modify translated text data 710. If after previewing the localized pages 706, it is determined at decision 708 that the pages, have been properly localized; the translated text data is stored at store translated text data 712. In some embodiments, the translated text data is stored in the same database from which the localizable text data was accessed. The process illustrated in FIG. 7 is merely one embodiment for translating text data according to the present invention.

In some embodiments, the present invention provides significant file management advantages over conventional processes for localizing documents. As previously described, conventional processes for localizing documents typically involve handing off a source document to translators who then hand back the translated document, and the source document. For every target language, the original source document is stored and saved with the translated documents to be able to keep track of the source document that correspond to the translated document. Accordingly, the conventional processes of localizing documents require a large number of files to be stored and managed. In some embodiments of the present invention, localizable terms are stored in a database that is structured to efficiently manage the localizable terms and to make the translation process more efficient. As an example, the localizable terms may be stored in a structured query language (SQL) database. The localizable terms may be stored in association with information that facilitates management of the localizable terms. Table 1 below provides an exemplary database schema that may be used to store and manage the localizable text data and the translations of the localizable terms.

TABLE 1
Exemplary Database Schema For Storing A Localizable Term

| Field | Description |
|---|---|
| PageID | Parent page |
| AssetID | Parent AssetID |
| Resource ID | Resource id within the page |
| Display ID | Display order within the page |
| Source | Source text |
| Target | Translated text |
| Translation Status | New, update, completed |
| Translation Origin | New, Offline, Online, AutoTranslated |
| Link Status | N/A (no links), No change, Localized (link |
| | modified), |
| Word count | Source text word count |
| Instruction | LocVer or other instruction |
| Comment | Other comments, bug fix info |
| Translation last | Time stamp |
| Updated | |
| Source Lock | Yes/no (translation not allowed) |
| Translation Lock | Yes/no (re-translation not allowed) |
| Target LCID | Target language ID |
| Source LCID | Source language ID |
| Source Origin | O11, O12, O13 (product version) |
| Source last updated | Time stamp |
| Category | Title, Para, List, link, etc |
| Check in/out | In, Out |
| Hash | (For the system) |
| Fuzzy match % | The match % between the old and the updated |
| | source |
| Previous source | The previous source to show the revision between |
| | the old and the updated source |

The schema illustrated in Table 1 includes a number of fields and description of the fields. It should be understood that the schema is intended to illustrate one possible structure for storing a localizable term in a database. As seen in Table 1, there are a number of fields that relate the localizable term to source documents. For example, the PageID, AssetID, ResourceID, DisplayID, all indicate or represent a relationship of the localizable term to the source document. The AssetID may relate generally to a source document from which the localizable term was extracted. For example, the AssetID may relate to a larger project that includes a number of documents, or to a single document (e.g., a pamphlet, a book or a web page) that the localizable term corresponds to. The PageID may relate to the specific page within the source document where the localizable term was extracted. Additionally, as described above, the ResourceID may identify the specific location within the document where the localizable term was extracted and what style information corresponds to the localized term. Finally, the DisplayID may indicate some other relationship of the localizable term with the source document, e.g., the order in which it is displayed on a page relative to other terms.

In some embodiments, the relationship information described above and stored in the database may be used in generating the localized documents. The process of generating the localized document may involve examining a field of the schema, containing data that represents a translated term, to retrieve the translated term. Next, the relationship information may be examined to determine how to incorporate the translated term into the localized document. As an example, the source document may include the localizable term “Hello” on page 3. A data structure for storing the term “Hello,” may include a field with data representing “Hello,” a field with data representing relationship information with the source document such as “page3,” and a field with data representing translated text data such as “Hola.” The process of generating a localized document, with “Hola,” may include retrieving the data representing “Hola,” examining the relationship information “page3,” and incorporating “Hola” into the localized document on page 3 based on the relationship information. This is only one example of utilizing fields in a database schema, such as relationship information, for generating localized documents, and others will be apparent to those with skill in the art.

Referring again to Table 1, in addition to relationship information, a schema for storing the localizable text data may also include fields that are useful in keeping track of the translation of the localizable text data. As stated above, the schema may include fields for the actual source text and the translated text. There may also be a field for indicating the status of translating the localizable text data, which may be set to “New” to indicate that the information has not been translated or “Translated” to indicate that the localizable text data has been translated. Additionally, there may be fields indicating whether the localized text data has been checked out or checked in for translation, as well as fields identifying a human translator or the method by which the localized text data was translated. Moreover, some fields may indicate the source language of the localizable text data as well as the target language of the translated text data.

In embodiments, the present invention provides for more easily translating updated documents. For example, it is common that during the lifetime of a project, documents in the source language may be updated by adding additional information to the document or editing portions of the existing material. In conventional processes there is no easy way to track these changes, resulting in the need to have an entire document retranslated, even if only a few changes have been made. In some embodiments of the present invention, the localizable text data is stored in a database as terms, i.e., words, phrases, sentences, paragraphs, or pages. These embodiments make translating updated documents more efficient. The changes in a source document may be tracked using the relationship information previously described above. When it is determined that a source document has been changed, the change to localizable terms may be noted in a database used to store the localizable terms. For example, referring again to Table 1, the schema used to store the localizable term may include a field for indicating the status of translating the localizable term, which may be set to “New” to indicate that the information has not been translated, “Translated” to indicate that the localizable text data has been translated, or “Updated” to indicate that the localizable term has been updated/changed and needs to be retranslated. In this way, only those portions of a source document that have been updated/changed are retranslated, saving time and effort.

In some embodiments, when documents are updated or revised in the source language, the revision management, described above for tracking the items modified, added or deleted from/to an original source document, can be performed on a client computer used to make the changes. In an alternative embodiment, the revision management can be performed on a centralized server to shield and hide the process of tracking the revisions from the client machine.

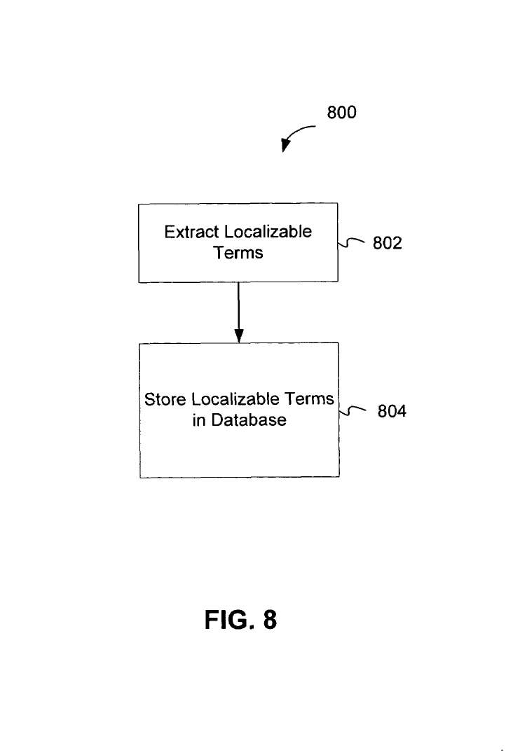

In some embodiments of the present invention, storing the localizable text data in a database in association with additional information provides improvements, over conventional processes, in control and management of large translation projects. FIG. 8 shows a flow chart 800 illustrating a process of managing the localization of source documents according to one embodiment of the present invention. The process includes extracting operation 802 to extract localizable terms from the source documents. The extracting operation 802 may be performed using any of the processes or applications previously described for extracting localizable terms from a document. The localizable terms are stored 804 in association with management information, after the extracting operation 802. By management information, it is meant any information that is useful for managing the localizable terms and the translation of the terms, including but not limited to relationship information indicating a relationship of the terms with the source document; translation status information indicating the translation status of localizable terms; method of translation information indicating a method by which the translatable terms have been translated; and target and source language identification information.

Process 800 provides the ability to measure, i.e., generate metrics showing, progress of large translation projects. As an example, the database may be searched to determine how many, or the percentage of, localizable terms that have been translated at a particular date that may be a milestone for the project. As another example, the database may be searched to determine the amount of translations being performed using a particular method, e.g., a human translator or automatic language translation software. The specific information that may be searched and used to manage projects will depend on the management information stored in the database in association with the localizable terms.

In embodiments of the present invention, translated terms stored in a database in association with localizable terms may be reused for generating a number of localized documents. Localizing a number of source documents inevitably involves retranslating the same terms on numerous occasions. For example, if two source documents include the term “the drop down menu,” the term will have to be translated each time it occurs for each localized document. In some embodiments, the present invention facilitates the reuse of translated terms stored in association with localizable terms. In these embodiments, the localizable terms and corresponding translated terms are stored in association with an identifier that corresponds to the term. The identifier may be predefined in a table that includes a list of terms and a list of corresponding identifiers. As an example, the localizable term “the drop down menu” may be associated with an ID#. When the term “the drop down menu” is extracted from a first source document, it will be stored in a database in association with the ID# and any translated term. When generating a localized document corresponding to the first source document, the ID# will be referenced and used to retrieve the translated term that is then incorporated into the localized document. Moreover, if a second source document also includes the term “the drop down menu,” a determination can be made that the term already exists and is stored in the database, with the corresponding translated term. Accordingly, when generating a second localized document corresponding to the second source document, the ID# may be referenced and used to incorporate the translated term into the second localized document. This advantageously avoids the need to retranslate the term “the drop down menu” for each of its occurrences. This is only one example of using stored translated terms, and those of skill in the art will appreciate other methods of reusing or recycling of translated terms corresponding to localizable terms.

Although the invention has been described in language specific to computer structural features, methodological acts and by computer readable media, it is to be understood that the invention defined in the appended claims is not necessarily limited to the specific structures, acts or media described. As an example, documents to be localized may be in any format and are not limited to an XML format as described with some of the exemplary embodiments. Additionally, extracted localizable text data may be stored in a database using any structure or schema that is suitable for storing the information. Therefore, the specific structural features, processes and mediums are disclosed as exemplary embodiments implementing the claimed invention.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

What is claimed is:

1. A computer implemented method of localizing a source document comprising localizable text data and a global presentation structure, the method comprising:
extracting the localizable text data from the source document, wherein the localizable text data comprises localizable terms;
providing access to the localizable terms to allow translation of the localizable terms into translated terms; and
generating a localized document corresponding to the source document, using the translated terms and the global presentation structure.

2. The method of claim 1, wherein the source document is in a markup language format.

3. The method of claim 2, wherein the markup language comprises XML.

4. The method of claim 1, wherein the extracting comprises use of a parser program.

5. The method of claim 1, wherein the extracting comprises tokenizing the source document to generate resource pages comprising the localizable text data and the global presentation structure comprising the style information.

6. The method of claim 5, wherein the global presentation structure is in an XML format.

7. The method of claim 6, wherein the translated terms are in an XML format and the generating comprises merging the translated terms with the global presentation structure.

8. The method of claim 1, wherein the providing access comprises allowing the localizable terms to be accessed over a network.

9. The method of claim 1, wherein at least a portion of the translated terms are reused in generating a second localized document corresponding to a second source document.

10. The method of claim 1, further comprising:
translating the localizable terms into the translated terms.

11. The method of claim 10, wherein the translating comprises use of automatic language translation software.

12. The method of claim 10, wherein the translating comprises use of a human translator.

13. The method of claim 10, wherein the localizable terms are stored in a database, and the translating comprises storing the translated terms in the database in association with the localizable terms.

14. A method of managing the localization of a source document in a source language, the method comprising:
extracting a plurality of localizable terms from the source document; and
storing each of the plurality of localizable terms in a database in association with management information, wherein the management information comprises:
relationship information indicating a relationship of the each of the plurality of localizable terms with the source document; and
translation status information indicating the status of translating the each of the localizable terms into translated terms in a target language.

15. The method of claim 14, further comprising searching the database to determine an amount of the plurality of localizable terms that have been translated into the target language.

16. The method of claim 14, wherein the management information further comprises translation method information indicating a method by which each of the translated terms have been translated.

17. The method of claim 14, wherein the database is an SQL database.

18. A computer-readable media having stored thereon a data structure comprising:
a first field containing data representing a localizable term extracted from a source document in a source language;
a second field containing data representing a relationship between the localizable term and the source document;
a third field containing data representing a translated term for incorporating into a localized document and generated by translating the localizable term into a target language; and
wherein when a localized document is generated, the translated term represented by data in the third field is incorporated into the localized document based on the relationship represented in the second field.

19. The computer-readable media of claim 18, wherein the data structure further comprises a fourth field containing data representing the source language.

20. The computer-readable media of claim 19, wherein the data structure further comprises a fifth field containing data representing the target language.
